(19) United States
(12) Patent Application Publication
(10) Pub. No.: US 2025/0162957 A1
(43) Pub. Date: May 22, 2025

(54) Adaptable Mobile Composting Systems, Devices, and Methods with Reduced Environmental Impact

(71) Applicant: Compost Colorado LLC, Boulder, CO (US)

(72) Inventor: Vann Fussell, Boulder, CO (US)

(21) Appl. No.: 18/638,059

(22) Filed: Apr. 17, 2024

Related U.S. Application Data
(60) Provisional application No. 63/497,367, filed on Apr. 20, 2023.

(51) Int. Cl. C05F 17/914; C05F 17/10; C05F 17/95; C05F 17/986

(52) U.S. Cl. CPC C05F 17/914; C05F 17/10; C05F 17/955; C05F 17/986

(57) ABSTRACT

The present disclosure relates to improved mobile composting systems, devices, and methods. In one example, a mobile composting system includes a garbage bin, a sorting table, a grinder, a conveyor belt, and a composting vessel. The garbage bin may include waste that includes compostable material. The sorting table may be adjacent to the garbage bin and may include a sorting surface configured to receive the waste and an inclined surface configured to receive the compostable material. The grinder may be positioned below the inclined surface for receiving the compostable material and may be configured to grind the compostable material and produce ground compostable material. The conveyor belt may have a first end positioned below the grinder to receive the ground compostable material. The composting vessel may be positioned below a second end of the conveyor belt.

### CROSS REFERENCE TO RELATED APPLICATIONS

The present application claims the benefit of priority to U.S. Provisional Patent Application No. 63/497,367, entitled “ADAPTABLE MOBILE COMPOSTING SYSTEMS, DEVICES, AND METHODS WITH REDUCED ENVIRONMENTAL IMPACT,” filed Apr. 20, 2023, the entirety of which is hereby incorporated by reference herein for all purposes.

### TECHNICAL FIELD

The technology described herein relates generally to improved composting systems, devices, and methods, specifically for reducing contamination to the environment and improving adaptability to varying environments.

### BACKGROUND

Composting is the controlled, aerobic decomposition of organic matter. During the composting process, organic waste is generally mixed with a bulking agent, such as wood chips, which increases porosity in the organic waste, allowing air to pass through the composting material more easily, thereby maintaining aerobic conditions. During the composting process, billions of bacteria in the organic matter ingest carbon compounds and reproduce, increasing the temperature of the organic matter. Under certain conditions, thermophilic bacteria thrive at these higher temperatures and rapidly transform the organic matter into compost. The three commonly used methods of composting include windrow, static aerated pile, and within-vessel.

Composting is considered a Process to Further Reduce Pathogens (PFRPs). When such processes are operated under certain specified conditions, pathogenic bacteria, enteric viruses, and viable helminth ova are reduced to below detectable levels. To be considered a PFRP, the composting operation must meet certain conditions. For within-vessel composting methods, the temperature of the organic waste is maintained at 131 degrees Fahrenheit or higher for 3 consecutive days.

There are various government regulations that govern composting processes. For example, the Colorado Department of Public Health and Environment has issued regulations pertaining to solid waste and composting processes. Such regulations govern various aspects of composting, including composting facility operations, facility designs (e.g., surface water control, odor control, etc.), compost processing time and temperatures (e.g., ensuring pathogen reduction and vector attraction), and the like.

The information included in this Background section of the specification, including any references cited herein and any description or discussion thereof, is included for technical reference purposes only and is not to be regarded subject matter by which the scope of the invention as defined in the claims is to be bound.

### SUMMARY

The disclosed technology includes improved composting systems, devices, and methods, specifically for reducing contamination to the environment and improving adaptability to varying environments. Embodiments of the present disclosure may include a mobile composting system that includes a sorting table, a grinder, and a conveyor belt. The sorting table may include a sorting surface and an inclined surface. The sorting surface may be configured to receive waste, the waste including compostable material, and the inclined surface may be configured to receive the compostable material. The grinder may be positioned below the inclined surface for receiving the compostable material, the grinder configured to grind the compostable material and produce ground compostable material. The conveyor belt may have a first end positioned below the grinder to receive the ground compostable material and a second end. Additionally or separately, the mobile composting system may include a garbage bin positioned adjacent to the sorting table and including the waste. Additionally or separately, the mobile composting system may include a garbage bin lifting mechanism, the garbage bin lifting mechanism may include a plurality of wheels to facilitate movement of a garbage bin relative to the sorting table. Additionally or separately, the mobile composting system may include a composting vessel positioned below the second end of the conveyor belt. Additionally or separately, the composting vessel may include a plurality of wheels.

Other examples or embodiments of the present disclosure may include a method of pre-processing compostable material. The method may include transferring waste including compostable matter onto a sorting table for sorting, wherein the sorting table includes a sorting surface and an inclined surface, and wherein transferring the waste onto the sorting table includes transferring the waste onto the sorting surface; removing non-compostable matter from the waste; and transferring the compostable matter from the sorting surface to the inclined surface, wherein the compostable matter slides down the inclined surface into a grinder positioned below the inclined surface and is ground inside the grinder into finer particles forming pre-processed compostable material.

Additional examples or embodiments of the present disclosure may include a method of in-vessel composting of pre-processed compostable material. The method may include receiving, at a first end of a conveyor belt, pre-processed compostable material, wherein the pre-processed compostable material has been sorted to remove non-compostable material and grinded into finer particles; transporting, via the conveyor belt, the pre-processed compostable material to a composting vessel located at a first location for composting, wherein the composting vessel is positioned at a second end of the conveyor belt, and wherein the composting vessel includes a plurality of wheels to facilitate moving the composting vessel to a second location.

Further examples or embodiments of the present disclosure may include a method of transporting a composting vessel from a first location to a second location for composting or maturation. The method may include attaching a cable to a fastening mechanism coupled to the composting vessel, wherein the cable is coupled to a truck bed in a first tilted position, wherein the composting vessel includes a composting vessel housing defining a composting vessel cavity holding pre-processed compostable matter or compost, a plurality of wheels coupled to the composting vessel housing, and wherein the composting vessel housing includes a bottom floor and a drain positioned on the bottom floor; rolling the composting vessel onto the truck bed using the cable and the plurality of wheels, wherein liquid from the pre-processed compostable matter or compost is collected in the drain; and transporting the composting vessel to a second location. Additionally or separately, the method may include lowering the composting vessel to a ground surface from the truck bed using the cable, wherein the truck bed is in a second tilted position; detaching the cable from the fastening mechanism; and allowing the pre-processed compostable matter to compost in the composting vessel for a period of 1-3 weeks.

Other examples or embodiments of the present disclosure may include a method of transferring compost from a composting vessel to a ground surface. The method may include opening a door of the composting vessel, wherein the composting vessel is in a tilted position on a truck bed of a roll off truck. The composting vessel may include a compost vessel housing defining a compost vessel cavity, wherein the compost vessel housing includes a bottom floor, and wherein the compost vessel cavity includes compost; a drain positioned on the bottom floor; a receptacle positioned below the drain; and a valve coupled to the receptacle. The method may include allowing the compost to fall out of the composting vessel and into a compost pile on the ground surface; placing a container under the receptacle; opening the valve to drain liquid collected in the receptacle into the container; and discarding the liquid from the container onto or near the compost pile.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

FIG. 1 is a simplified block diagram of an improved composting system.

FIG. 2 is a front isometric view of a sorting table that can be used with the improved composting system of FIG. 1.

FIG. 3 is a top rear isometric view of the sorting table of FIG. 2 with organic matter.

FIG. 4 is a rear isometric view of the sorting table of FIG. 2 positioned on a sorting platform.

FIG. 5 is a right side isometric view of a sorting and grinding system that can be used with the improved composting system of FIG. 1.

FIG. 6 is a front isometric view of a composting vessel that can be used with the improved composting system of FIG. 1.

FIG. 7 is a left side view of the composting vessel of FIG. 6.

FIG. 8 is a top rear isometric view of the composting vessel of FIG. 6.

FIG. 9 is a front isometric view of the composting vessel of FIG. 6 with the doors in open positions.

FIG. 10 is a rear isometric view of the composting vessel of FIG. 6 incorporating piping and a blower.

FIG. 11 is a flow chart illustrating a method of pre-processing organic matter prior to composting.

FIG. 12 is a flow chart illustrating a method of transporting pre-processed organic matter to a site for composting.

FIG. 13 is a flow chart illustrating a method of distributing compost.

### DETAILED DESCRIPTION

This disclosure is related to improved composting systems, devices, and methods, specifically for reducing contamination to the environment and improving adaptability to varying environments. Disclosed composting systems, devices, and methods may reduce contamination to the environment, which is often a byproduct of composting. In several embodiments, disclosed composting systems, devices, and methods include a sorting table for sorting out non-compostable waste, which can leach toxins into the ground or ground water. Disclosed composting systems, devices, and methods may have improved mobility or transportability, allowing composting to take place in a greater number of locations, including smaller urban environments. Further, the improved mobility may facilitate transportation of compost to a desired location for spreading and use. In several embodiments, disclosed composting systems, devices, and methods include a readily transportable composting vessel. The composting vessel may include wheels to facilitate rolling the vessel on and off from truck beds, such as those of roll off trucks.

Conventional composting methods often involve a dump truck that picks up garbage bins or totes from residences and commercial properties and distributes the collected waste into a pile on the ground for composting. Conventional composting methods fail to screen or sort out non-compostable matter, contaminants, or toxic matter from the compostable matter prior to composting. Accordingly, the waste piles often have non-compostable matter, including contaminants and toxins that leach into the ground and ground water as they sit in the sun.

Composting is often divided into three phases or stages: the mesophilic stage, the thermophilic stage, and the maturation or curing stage. The mesophilic stage is dominated by mesophilic bacteria, and the waste heap begins to warm up as these bacteria produce heat. As the heat increases, thermophilic bacteria take over at the thermophilic stage, generating even higher temperatures. As the thermophilic bacteria use up readily available proteins, fats, and complex carbohydrates, the compost enters the maturation stage where tougher material is broken down by physical decomposers (e.g., worms, woodlice, slugs, snails, etc.). During the maturation stage, a series of secondary reactions occur at room temperature.

Disclosed composting systems, devices, and methods add a pre-processing stage before the mesophilic stage. The pre-processing stage may include two separate stages: a sorting stage and a grinding stage. In the sorting stage, non-compostable matter, non-organic matter, contaminants, or toxic matter may be screened or sorted out from the compostable or organic matter prior to composting (or prior to the mesophilic stage). In the grinding stage, the sorted compostable matter may be ground into finer particles prior to composting (or prior to the mesophilic stage).

Disclosed composting systems may include one or more garbage bins, a sorting table, a grinder, a conveyor belt, and a composting vessel for in-vessel composting. The garbage bins may include waste, which may be emptied onto the sorting table for sorting out non-compostable or non-organic materials from the compostable or organic materials. The sorted compostable material may be transferred to the grinder to be ground into finer particles, and the sorted and ground compostable material may be transferred via the conveyor belt to the composting vessel for composting. One or more of the composting system components may have wheels to facilitate movement of the one or more components relative to one another and relative to the layout of the environment, enabling disclosed composting systems to accommodate different spaces. The design of composting systems and devices described herein may be such that the system, or components thereof, may be configured to fit tight or small urban environments, spaces, or footprints. In this manner, disclosed composting systems may allow for composting at various locations and spaces previously unavailable for composting.

Conventional in-vessel composting processes typically use large, expensive, or immobile vessels. Such vessels are often maintained at the composting site for composting. The composting vessels described herein have improved transportability, allowing for greater location flexibility for the composting and/or compost maturation processes. For example, by including wheels on the bottom surface or floor of the composting vessel, the composting vessel may be easily rolled onto a truck bed and transported to another location.

By using the same composting vessel for both compost processing and transportation of compostable waste or compost, disclosed composting systems, devices, and methods may reduce operational time associated with loading, unloading, and moving materials. Such dual purpose use of disclosed composting vessels may also reduce how often the waste needs to be handled (e.g., with a skid steer, tractor, loader, or the like).

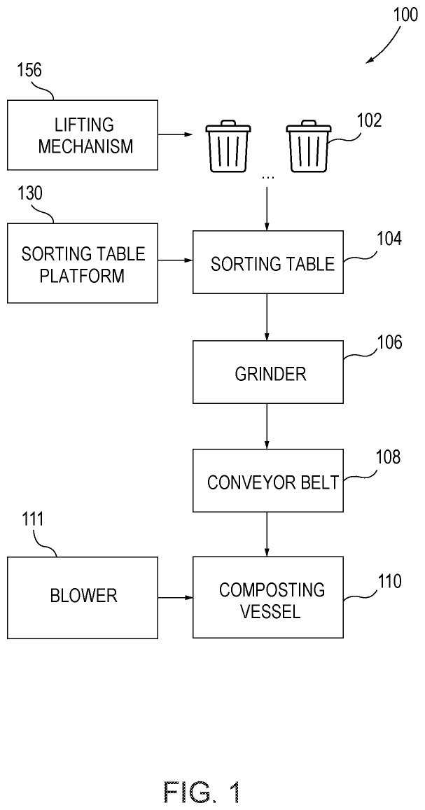

FIG. 1 is a simplified block diagram of an improved composting system. As shown, the composting system 100 may include one or more of one or more trash/garbage bins/cans or totes 102, a sorting table 104, a grinder 106, a conveyor belt 108, and a composting vessel 110. The one or more garbage bins 102 may be any conventional garbage bin, such as a conventional 64 gallon tote. The size of the one or more garbage bins 102 may vary. The one or more garbage bins 102 may house waste intended for composting. The waste may be post-consumer waste. The waste may include both compostable waste and non-compostable waste. For example, garbage bins 102 intended for compostable waste may, in some instances, include non-compostable waste (e.g., often by chance or accident). As one example, produce stickers, which are non-compostable, may end up in a compost garbage bin 102.

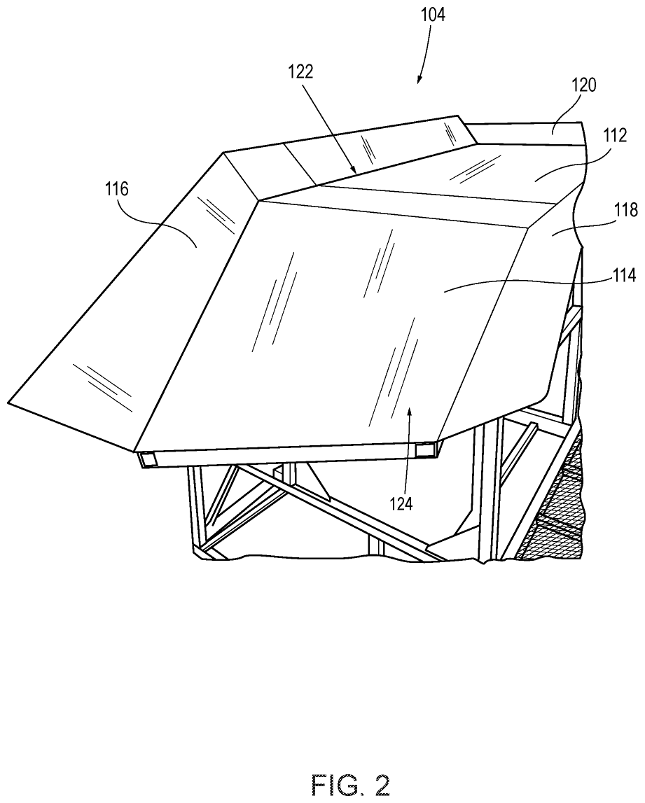

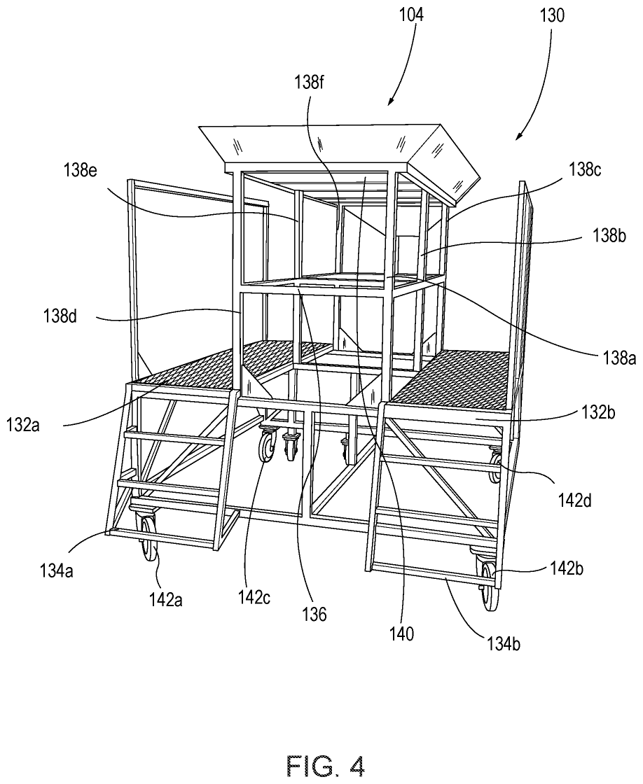

The sorting table 104 may be a specialized table designed for collecting and sorting compostable waste. The sorting table 104 may be sized to hold a load of waste from a conventional 64 oz. garbage can. An example of a disclosed sorting table 104 is described in detail with respect to FIGS. 2-4. The sorting table 104 may be positioned on a sorting table platform 130. The sorting table platform 130 may raise the sorting table 104 a height off the ground such that the grinder 106 may be positioned under the sorting table 104. The sorting table platform 130 may have wheels to facilitate moving the sorting table 104 to different locations, for example, to position the sorting table 104 adjacent to a grinder 106 and/or to a composting vessel 110. An example of a disclosed sorting table platform 130 is described in detail with respect to FIG. 4.

The waste from the one or more garbage bins 102 may be dumped onto the sorting table 104. For example, the one or more garbage bins 102 may be lifted to above a height of the sorting table 104 and tilted to empty the waste contained therein by a lifting mechanism 156. As discussed below, the lifting mechanism 156 may be any conventional lifting or pulley mechanism or conventional bin lifter and tipper. It is contemplated that the lifting mechanism 156 may have wheels to facilitate movement of the one or more garbage bins 102 relative to a position of the sorting table 104.

The grinder 106 may be any conventional grinder used to grind waste for composting. The grinder 106 may be positioned at an end of the sorting table 104 to receive the pre-sorted compostable matter. The conveyor belt 108 may be coupled to, integrated with, or positioned adjacent to the grinder 106, for example, positioned below the grinder 106. The conveyor belt 108 may receive the pre-sorted and ground (“pre-processed”) compostable matter from the grinder 106 and transport it to the composting vessel 110. The grinder 106 and conveyor belt 108 may include wheels, or may be coupled to a platform that includes wheels, to facilitate positioning of the grinder 106 and conveyor belt 108 relative to the sorting table 104 and the composting vessel 110. The conveyor belt 108 may be moveable separate from the grinder 106 or together with the grinder 106 if the conveyor belt 108 is coupled to or integrated with the grinder 106. The conveyor belt 108 may be positioned in various orientations or directions (e.g., depending on the positioning of the composting vessel 110 relative to the grinder 106).

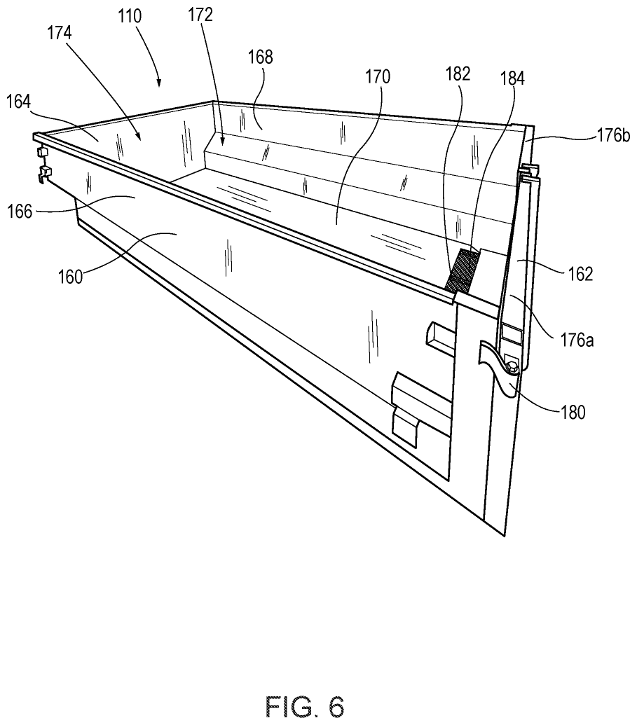

The composting vessel 110 may house the pre-processed compostable material for composting. The composting vessel 110 may include wheels to facilitate movement of the composting vessel 110. For example, the composting vessel 110 may be moved relative to the sorting table 104. As another example, the composting vessel 110 may be more readily transported with the pre-processed compostable material to a second location (e.g., a location separate from the location of the pre-processing stage) for composting. As yet another example, the composting vessel 110 may be more readily transported with compost to a second location (e.g., a location separate from the location of the mesophilic and thermophilic stages) for maturation. For example, the wheels may facilitate rolling the composting vessel 110 onto and off from a truck bed. An example of a disclosed composting vessel 110 is described in detail with respect to FIGS. 6-9.

A lid may be positioned over the top of the composting vessel 110 to contain the compostable material in an aerobic environment and prevent excess heat from escaping during the composting process. One or more sensors may be positioned inside or coupled to the composting vessel 110. For example, a temperature probe or sensor may be positioned in the composting vessel 110 cavity for reading temperature during the composting process. The temperature probe or sensor may transmit temperature data to a user device (e.g., smartphone) related to the temperature reading so that temperature may be monitored remotely. Composting in the composting vessel 110 may be determined to be complete when a certain temperature is reached, as discussed more below. Other sensors are contemplated, such as a moisture or humidity sensor.

In some embodiments, the composting system 100 may include a blower 111. The blower 111 may be a fan or other device for blowing air into the composting vessel 110. The blower 111 may be positioned outside and adjacent to the composting vessel 110. As an example, the blower 111 may be positioned on top of the composting vessel 110. It is contemplated that the blower 111 may be battery operated to allow greater flexibility in where the composting system 100 can be located or positioned. While the composting system 100 is described with respect to various system components, it is contemplated that one or more of the components may be omitted.

As discussed above, one or more of the composting system 100 components may include wheels. The wheels may facilitate transportation of the entire composting system 100, or components thereof, to a new location. The wheels may also facilitate movement of the composting system 100 components relative to one another. The flexible arrangement or positioning of the components of the composting system 100 may enable the composting system 100 to fit in different spaces, providing improved flexibility as to the locations where pre-processing and composting can occur.

The composting system 100 may be considered a mobile organics materials recovery facility (MRF). Conventional MRFs are typically large, stationary facilities where recyclable materials are sorted, processed, and recovered to be reused as raw materials. The mobile organics MRF described herein has improved adaptability and flexibility over conventional MRFs, as the mobile organics MRF may be utilized in different locations due to the portability of one or more of its components (e.g., one or more of the sorting table 104, the grinder 106, the conveyor belt 108, the composting vessel 110, etc.) and its condensed size compared to conventional MRFs. The disclosed mobile organics MRF may facilitate sorting, processing, and recovery of organic materials from waste, which is not achieved by conventional MRFs that are limited to sorting, processing, and recovering recyclables based on size, weight, and material. Further, conventional MRFs include a compacting process that compacts the recyclables into bales that are tied together with a bailing wire. In contrast, in several embodiments, the disclosed mobile organics MRF includes a grinding process that grinds the organic materials into finer particles with increased surface area to facilitate the composting process. As such, disclosed mobile organics MRFs provide improved sorting, processing, and recovery of organic materials for composting, which is not achieved by conventional MRFs.

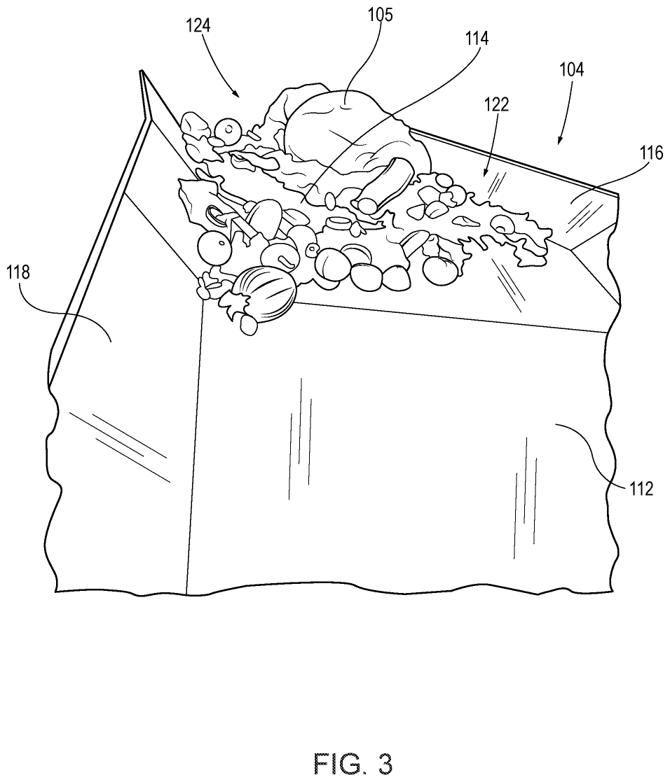

FIG. 2 is a front isometric view of an exemplary sorting table 104 that can be used with the improved composting system 100 of FIG. 1. FIG. 3 is a top rear isometric view of the sorting table 104 of FIG. 2 with compostable matter 105. As shown in the figures, the sorting table 104 may include a sorting surface 112 and a slide or inclined or pitched surface 114. The sorting surface 112 may be relatively flat and the inclined surface 114 may extend in a downward incline away from the sorting surface 112. A left side wall 116 and right side wall 118 may be positioned on opposing sides of the sorting surface 112 and inclined surface 114. A rear wall 120 may be positioned at a rear end of the sorting surface 112. The left and right side walls 116, 118, rear wall 120, and the sorting and inclined surfaces 112, 114 may form a sorting table cavity 122. A sorting table opening 124 to the sorting table cavity 122 is positioned at a front end of the inclined surface 114. The sorting table cavity 122 may be sized for a 64 gallon load of waste (e.g., a single 64 gallon tote load). It is contemplated that a surface area of the sorting surface 112 is sized to hold a 64 gallon load of waste. The sorting table 104 size may vary to accommodate different waste loads. As one example, the sorting table 104 may be 20 ft. long X 4 ft. wide. The left and right side walls 116, 118 and rear wall 120 may prevent waste material from falling off the sorting and inclined surfaces 112, 114 to the ground or floor. The inclined surface 114 may facilitate sliding of the sorted compostable matter 105 off the sorting table 104 in a directed manner (e.g., out the sorting table opening 124). The sorting table may be made of a durable metal, such as steel or stainless steel.

In some embodiments, the sorting table 104 includes a splash guard. The splash guard may be coupled to the left side wall 116 and right side wall 118 to prevent individuals sorting waste on the sorting table 104 from being splashed by the waste. For example, the splash guard may be positioned on opposing sides of the sorting surface 112. The splash guard may be extendable and retractable or removable. For example, the splash guard may be extended when waste is unloaded onto the sorting table 104 and retracted or removed thereafter prior to the sorting process.

In some embodiments, the sorting table 104 includes a gate or divider proximate to the sorting table opening 124 or near an end of the sorting surface 112. The gate or divider may be perpendicular to the sorting table surface 112 or the inclined surface 114 and extend across a width of the sorting table 104 (e.g., from the left side wall 116 to the right side wall 118). The gate or divider may prevent heavy, unwanted waste from sliding down the inclined surface 114 and out the sorting table opening 124 into the grinder 106, which could damage the grinder 106. For example, a rock in the waste may be heavy and could slide down the inclined surface 114 into the grinder, which could result in damage to the grinder. In some embodiments, the gate may be electrically or manually opened or the divider may be removed to allow sorted compostable matter to exit out the sorting table opening 124 and into the grinder 106. In this manner, the gate or divider may further prevent contamination of the compostable matter.

FIG. 4 is a rear isometric view of the sorting table 104 of FIG. 2 positioned on a sorting platform 130. The sorting platform 130 may include one or more standing platforms to accommodate one or more people or sorters who can stand on the one or more standing platforms and sort non-compostable matter or contaminants out of the compostable matter. As shown, the sorting platform 130 includes two standing platforms 132a,b. The standing platforms 132a,b include ladders 134a,b, respectively, at an end. The sorting platform 130 includes a sorting table stand 136. The sorting table stand 136 includes a plurality of vertical metal rods or bars 138a,b,c,d,e,f that extend up from the standing platforms 132a,b to a sorting table stand surface 140. The sorting table stand 136 holds the sorting table 104 on the sorting table stand surface 140 a distance D from the standing platforms 132a,b. The distance D may be sized to accommodate an average female and/or male height so that sorters are not straining to reach the sorting surface 112 to sort waste contained thereon. As shown, the sorting platform 130 includes a plurality of sorting platform wheels 142a,b,c,d. The sorting platform wheels 142a,b,c,d may facilitate moving or transporting the sorting table 104 to different locations. For example, the sorting table 104 may be moved on the sorting platform 130 adjacent to different composting vessels. While four sorting platform wheels 142a,b,c,d are shown, more or less wheels are contemplated.

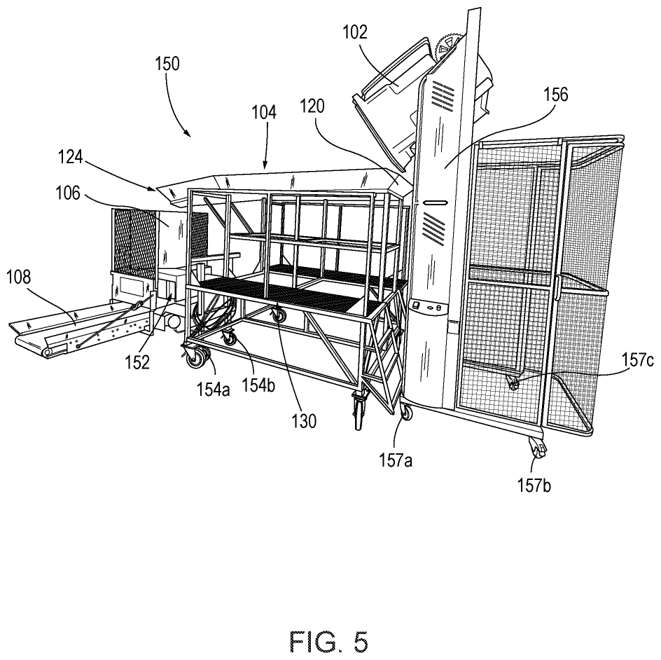

FIG. 5 is a right side isometric view of a sorting and grinding system 150 that can be used with the improved composting system of FIG. 1. The sorting and grinding system 150 includes the exemplary sorting table 104 described with respect to FIGS. 2-3, the sorting platform 130 described with respect to FIG. 4, an exemplary grinder 106, and an exemplary conveyor belt 108. As discussed, the grinder 106 may be any conventional grinder. As an example, the grinder 106 may have an opening at the top providing an opening to a grinder cavity that contains teeth or gears for grinding materials therein. As shown, the grinder 106 is positioned adjacent to, proximate to, and/or below or under the inclined surface 114 of the sorting table 104 and the sorting table opening 124. As discussed above, pre-sorted compostable material may be pushed down or may slide down the inclined surface 114, out the sorting table opening 124 and into the grinder 106 via the grinder top opening.

The grinder 106 may include the conveyor belt 108 or the grinder 106 may be a separate component from the conveyor belt 108. In the depicted embodiment, the grinder 106 and conveyor belt 108 are coupled to a grinder platform 152. The grinder platform includes a plurality of grinder platform wheels 154a,b. While two grinder platform wheels 154a,b are depicted, it is contemplated that more or less wheels may be included. The conveyor belt 108 is positioned adjacent to, proximate to, or under the grinder 106. The grinder 106 may include an opening at a bottom of the grinder 106. The bottom opening may be under the teeth or gears positioned inside the grinder cavity such that the pre-sorted compostable material passes through the teeth and out the bottom opening due to gravity. The pre-processed compostable matter may pass out the bottom opening of the grinder 106 onto the conveyor belt 108. The conveyor belt 108 may in turn transport the pre-processed compostable matter to a composting vessel.

The sorting and grinding system 150 may be moved via the sorting platform wheels 142a,b,c,d and grinder platform wheels 154a,b to a location that facilitates dumping of the pre-processed compostable material into a composting vessel. In the depicted example, the sorting and grinding system 150 is positioned on a ledge. The ledge may facilitate moving a composting vessel under the conveyor belt 108. It is contemplated that components of the sorting and grinding system 150 may be moved individually. For example, the sorting table 104 and sorting platform may be kept in the same place while the grinding platform 152 is transported, via the grinder platform wheels 154a,b, to a position closer to the composting vessel. In the depicted example, a garbage bin 102 is emptied on a rear end of the sorting table 104, near the rear wall 120. As shown, the garbage bin 102 may be lifted above the sorting table 104 by a lifting mechanism 156. The lifting mechanism 156 may be any conventional lifting or pulley mechanism or conventional bin lifter and tipper. The lifting mechanism 156 may include both lifting and tilting functionalities to lift and tilt a garbage bin 102. The lifting mechanism 156 may be positioned on wheels 157a,b,c (the fourth wheel is not shown) for ease of transportation of the garbage bin 102 to the sorting table 104.

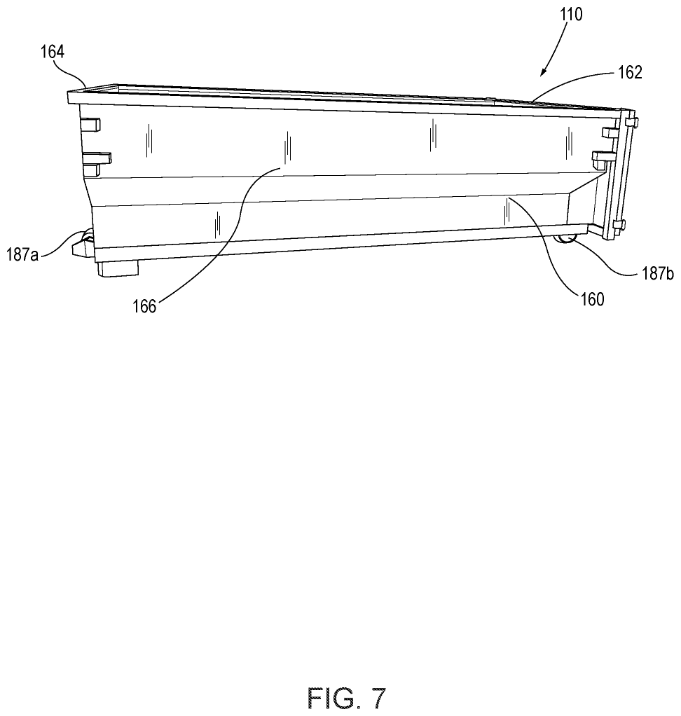

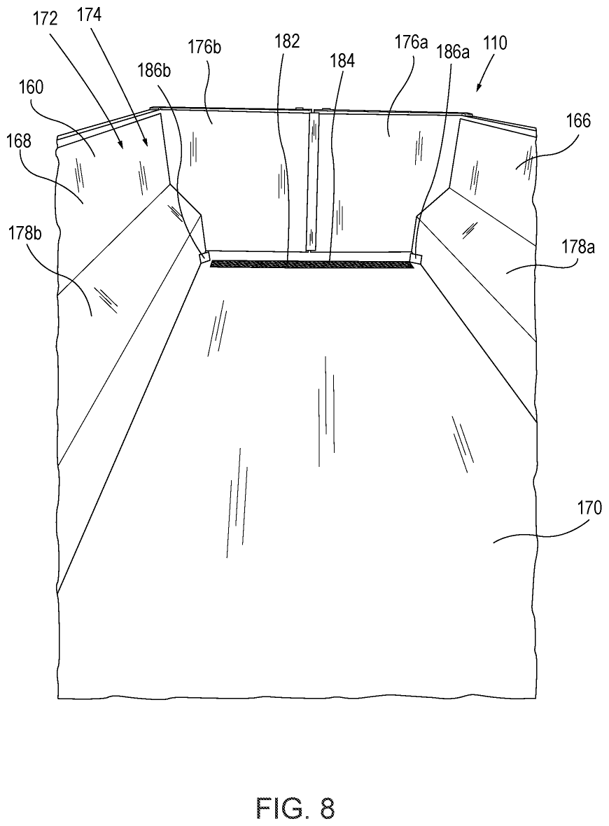

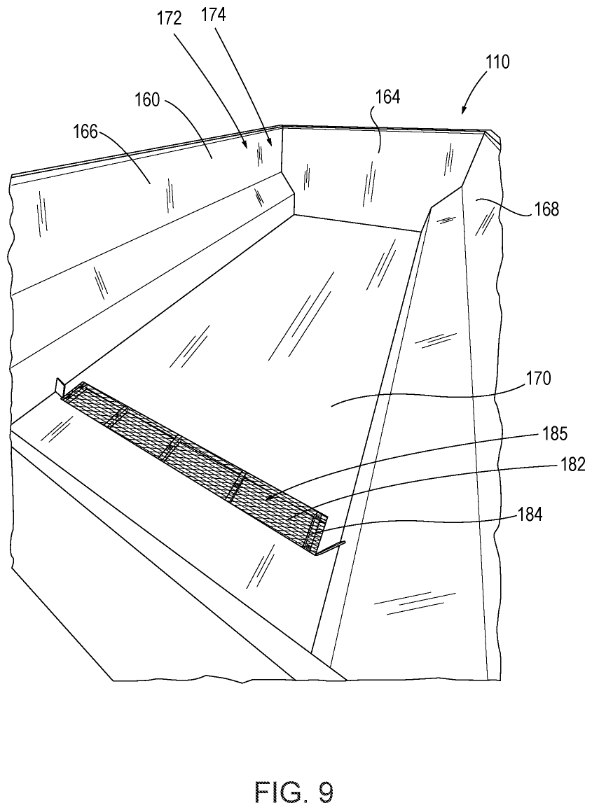

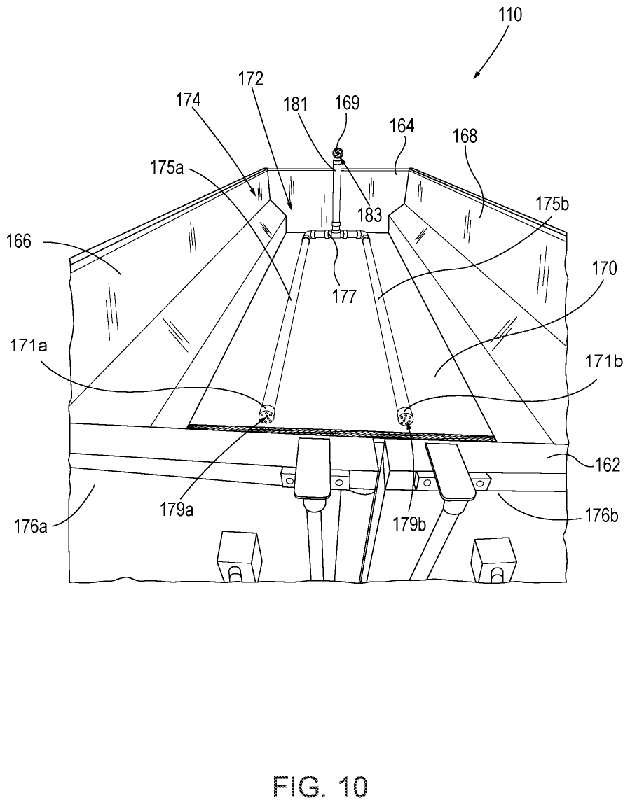

FIG. 6 is a front isometric view of an exemplary composting vessel 110 that can be used with the improved composting system of FIG. 1. FIG. 7 is a left side view of the composting vessel 110 of FIG. 6. FIG. 8 is a top rear isometric view of the composting vessel 110 of FIG. 6. FIG. 9 is a front isometric view of the composting vessel 110 of FIG. 6 with the doors in open positions. FIG. 10 is a rear isometric view of the composting vessel of FIG. 6 incorporating piping and a blower. As shown in FIGS. 6-10, the composting vessel 110 includes a vessel housing 160. The vessel housing 160 includes a front vessel wall 162, a rear vessel wall 164, a left vessel side wall 166, a right vessel side wall 168, and a bottom vessel floor 170. The vessel housing 160 forms a vessel housing cavity 172 with a vessel opening 174 to the vessel housing cavity 172. It is contemplated that the vessel housing cavity 172 may hold up to 10 cubic yards of compostable waste; however, different sizes are contemplated. By limiting the capacity to 10 cubic yards or less, disclosed composting vessels may satisfy solid waste regulations and avoid costly regulations and permits. It is contemplated that the vessel housing cavity 172 may hold an amount of waste or compost that has a weight that meets commercial driver's license (CDL) requirements. For example, the vessel housing cavity 172 may be sized such that the total weight of the composting vessel 110 and its contents weigh no more than 18,000 lbs. to meet CDL requirements. By maintaining the composting vessel 110 at a weight that can be carried by a CDL truck, disclosed systems and methods may be more readily adaptable and operational.

In the depicted embodiment, the front vessel wall 162 is formed by a left vessel door 176a and a right vessel door 176b. The left vessel door 176a is hingedly coupled to the left vessel side wall 166 by a hinge 180. The right vessel door 176b is hingedly coupled to the right vessel side wall 168 by a hinge (mirror image of hinge 180). The left vessel side wall 166 and right vessel side wall 168 include vessel extrusions 178a,b, respectively, that narrow a surface area of the bottom vessel floor 170 from that of the vessel opening 174. It is contemplated that the vessel extrusions 178a,b may be omitted. A left and right guide 186a,b, respectively, may extend up from the bottom vessel floor 170. As shown the left and right guides 186a,b are positioned proximate to the left and right vessel doors 176a,b, respectively. The left and right guides 186a,b are angled from the vessel extrusions 178a,b towards the left and right vessel doors 176a,b, respectively.

The bottom vessel floor 170 may include a drain 182. As shown, the drain 182 is positioned proximate to the left and right vessel doors 176a,b. In the depicted example, the drain 182 extends between edges of the guides 186a,b. The guides 186a,b may help to filter or guide excess liquid into the drain 182. It is contemplated that the drain 182 may extend across the width of the bottom vessel floor 170, for example, between the vessel extrusions 178a,b. The drain 182 may include a grate 184 for filtering out solid matter from liquid matter that flows through the drain 182. A basin or receptacle 185 may be positioned below the drain 182 to receive fluid that passes therethrough. It is contemplated that the drain 182 may be in a different position. For example, the drain 182 may be a gutter or part of an extension positioned on an exterior of the composting vessel 110, proximate to the left and right vessel doors 176a,b.

The drain 182 may catch liquid before it flows out of cracks in the left and right vessel doors 176a,b, thereby preventing the liquid from leaking out of the composting vessel 110, for example, during transportation. Liquid leaking out of the composting vessel 110 may be undesirable as it may produce an unwanted odor and/or pose an environmental hazard. By including a drain 182 in the bottom vessel floor 170, disclosed composting vessels facilitate transportation of compostable material and/or compost while mitigating environmental impact. In some embodiments, the composting vessel 110 may have walls that are fully sealed or airtight or leak proof. In these embodiments, the drain 182 may be omitted.

The composting vessel 110 may include a plurality of composting vessel wheels. For example, the composting vessel 110 may include four wheels. In the depicted embodiment, two of the four wheels are shown, specifically a rear left wheel 187a and a front left wheel 187b. The rear right wheel and front right wheel are mirror images of the rear left wheel 187a and front left wheel 187b, respectively. As shown, the rear left wheel 187a and rear right wheel are coupled to the rear wall 164. The front left wheel 187a and front right wheel are positioned under the bottom vessel floor 170 proximate to the left vessel side wall 166 and right vessel side wall 168, respectively, and proximate to the front wall 162. The wheels 187a,b may be arranged in a similar manner as the wheels on a roll off container. It is contemplated that the rear left wheel 187a and rear right wheel may be positioned under the bottom vessel floor 170 proximate to the rear wall 164, similar to the positioning of the front left wheel 187b and front right wheel proximate to the front wall 162. It is contemplated that more or less composting vessel wheels may be included.

In some embodiments, the composting vessel 110 may include one or more pipes (e.g., PVC pipes) in the vessel housing cavity 172. For example, the one or more pipes may be positioned along the bottom vessel floor 170. The one or more pipes may pass through one or more of the walls of the vessel housing 160 (e.g., the front vessel wall 162, rear vessel wall 164, left vessel side wall 166, right vessel side wall 168) to pull in air from outside the composting vessel 110. The one or more pipes may pass through a lid or cover that is positioned over the vessel opening 174. The one or more pipes may allow air to pass through the compostable waste contained in the vessel housing cavity 172 for a more efficient aerobic environment for the composting process. As discussed, a blower (e.g., blower 111 of FIG. 1) may be positioned proximate to or coupled to the composting vessel 110. The blower may be positioned such that it pushes air through the one or more pipes. As an example, the blower may be positioned above a pipe that extends through the lid or cover to blow air from above the composting vessel 110 into the vessel housing cavity 172.

FIG. 10 shows an exemplary embodiment of the composting vessel 110 including the one or more pipes and blower. As shown, two horizontal pipes 175a,b extend along the bottom vessel floor 170 and are coupled together by an intermediary pipe 177. The two horizontal pipes 175a,b each have pipe openings 179a,b, respectively. The pipe openings 179a,b depicted in the present embodiment include a plurality of holes defined within pipe caps 171a,b covering the end openings of the pipes 175a,b, respectively. It is contemplated that the pipe caps 171a,b may be omitted and the pipe openings 179a,b may be the end openings of the pipes 175a,b. A vertical pipe 181 extends upwards adjacent to or proximate to the rear vessel wall 164. The vertical pipe 181 includes an opening 183. The vertical pipe 181 may pass through an opening in a lid or cover placed over top of the vessel opening 174. A seal may be formed around the vertical pipe 181 to prevent air flow and release of heat through the lid or cover opening. A blower 169 may be coupled to the vertical pipe 181 or positioned next to or adjacent to the opening 183. As shown, the blower 169 includes blades positioned within the opening 183. It is contemplated that the blower 169 may be separate from the pipes. For example, a fan may be positioned on top of the lid or cover next to the opening 183 when the lid or cover is placed over the vessel opening 174. The blower 169 may blow air from outside the composting vessel 110 through the opening 183, into the horizontal pipes 175a,b, and out the pipe openings 179a,b, thereby aerating the waste contained inside the vessel housing cavity 172 from the bottom up towards the lid or cover.

The composting vessel 110 may be made of metal, e.g., steel or stainless steel. In some embodiments, the composting vessel 110 may include a heat resistant and/or corrosion resistant layer inside the vessel housing cavity 172 (e.g., on an interior surface of the composting vessel 110). The heat resistant or corrosion resistant layer may be organic material. For example, the heat resistant layer may be a coating, such as vegetable oil. Vegetable oil may prevent corrosion of the vessel housing 160, while preventing contamination of the pre-processed compostable matter contained therein, as vegetable oil is an organic waste. As another example, a corrosion-resistant tarp or sheet may line the interior of the vessel housing cavity 172. The corrosion-resistant tarp may be coupled to the vessel housing 160 or removable from the vessel housing cavity 172. For example, the corrosion-resistant tarp may be replaced after each use (e.g., each composting cycle). The corrosion-resistant tarp may also prevent leaks through cracks in the vessel housing 160. It is contemplated that the corrosion-resistant tarp may be made of polymer or an organic material (e.g., to prevent leaching into the waste/compost).

In several embodiments, the composting vessel is a modified roll off dumpster or container. The roll off dumpster may be modified to include a drain on a bottom surface (e.g., the drain 182 positioned on the bottom vessel floor 170, as described with respect to FIGS. 6-9). The drain may catch leachate or wastewater. The drain may prevent excess liquid from spilling out of cracks in the doors and being spread in undesirable locations as the composting vessel is transported, as described above. The interior surfaces may be coated with a heat resistant organic material to prevent corrosion as the temperature rises and acids are released during the composting process. The heat resistant organic material may include vegetable oil, as described above. In some embodiments, cracks in a roll off dumpster may be sealed. For example, a biodegradable compost sock may be used along the edges of the roll off dumpster. As another example, organic materials may be used as a seal (e.g., saw dust, wood chips, dry mushroom blocks, etc.).

The exterior surfaces of the composting vessel 110 may include an insulating material or coating to prevent excess heat from escaping during the composting process to expedite the in-vessel composting process. In some embodiments, the composting vessel 110 may have a decorative exterior to improve attractiveness of the composting vessel 110 when it is positioned in a public space (e.g., when composting occurs at a site separate from the sorting and grinding process).

The composting vessel 110 may be where the composting process occurs. By composting in the composting vessel 110, composting conditions may be controlled. The composting process may be allowed to proceed inside the composting vessel 110 for about 1-3 weeks.

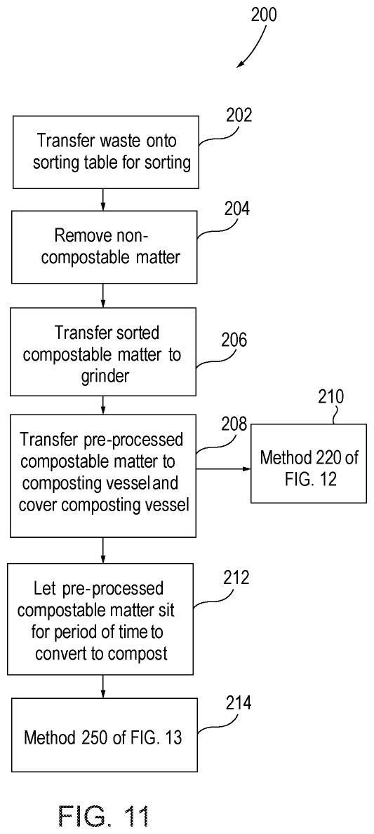

FIG. 11 is a flow chart illustrating a method of pre-processing compostable or organic matter prior to composting. The pre-processing method 200 begins with operation 202 and waste is transferred onto a sorting table for sorting. The sorting table may be the sorting table 104 described above with respect to FIGS. 2-4. The waste may be contained in a garbage bin 102. The garbage bin 102 may be raised above or partially above the sorting table 104 near the rear wall 120 by a lifting mechanism (e.g., as shown by the lifting mechanism 156 shown in FIG. 5). The garbage bin 102 may be tilted (e.g., via a tilting mechanism coupled to the lifting mechanism) and the waste contents emptied out of the garbage bin 102 and transferred onto the sorting surface 112 of the sorting table 104.

After operation 202, the method 200 may proceed to operation 204 and non-compostable matter may be removed from the waste. For example, the sorting table 104 may be held on a sorting platform (e.g., sorting platform 130 shown in FIGS. 4-5). One or more sorters may stand on the standing platforms 132a,b and sort the waste on the sorting surface 112. For example, the one or more sorters may pull out non-compostable waste from the waste.

After operation 204, the method 200 may proceed to operation 206 and the sorted compostable matter may be transferred to a grinder. For example, the one or more sorters may push the sorted compostable matter or waste towards the inclined surface 114 and the sorting table opening 124. The inclined surface 114 may help the compostable matter slide towards and out the sorting table opening 124 and into a top opening in the grinder. The grinder may be the grinder 106 described above. The compostable matter may pass through grinder teeth or gears positioned inside the grinder cavity and be ground into finer grains or particles. The increased surface area of the ground compostable matter may facilitate the composting process. The ground compostable matter may exit out a bottom opening of the grinder.

After operation 206, the method 200 may proceed to operation 208 and the pre-processed compostable matter may be transferred to a composting vessel and the composting vessel covered. The pre-processed compostable matter may be transferred to the composting vessel via a conveyor belt (e.g., conveyor belt 108 described above). The composting vessel may be the composting vessel 110 described above with respect to FIGS. 6-9. As discussed, the conveyor belt 108 may be positioned under the grinder 106 and may receive the ground compostable matter or pre-processed compostable matter. The composting vessel 110 may be positioned at an opposing end of the conveyor belt 108 from the grinder 106. The pre-processed compostable matter may travel along the belt toward the composting vessel 110. The composting vessel 110 may be positioned under the conveyor belt 108 and the pre-processed compostable matter may fall into the vessel housing cavity 172 through the vessel opening 174. Operations 202-208 may be repeated with different garbage bins 102 to fill the composting vessel 110. As a non-limiting example, waste from eight garbage bins 102 may be sorted, ground, and transferred to the composting vessel 110. In some embodiments, the method 200 may alternate between garbage bins 102 holding different types of waste. For example, the method 200 may alternate between garbage bins 102 holding food waste and yard/plant waste. By alternating between food and plant waste, the compostable material in the composting vessel 110 may be mixed or homogeneous. A lid or cover may be placed over top of the vessel opening 174. The lid or cover may trap heat to facilitate or expedite the composting process and prevent or minimize odor emitted from the composting vessel 110. The lid or cover may be coupled to the vessel housing 160 or removable. The lid may be metal (e.g., stainless steel) or an organic material (e.g., wood). As one example, the lid may be a piece of reclaimed plywood.

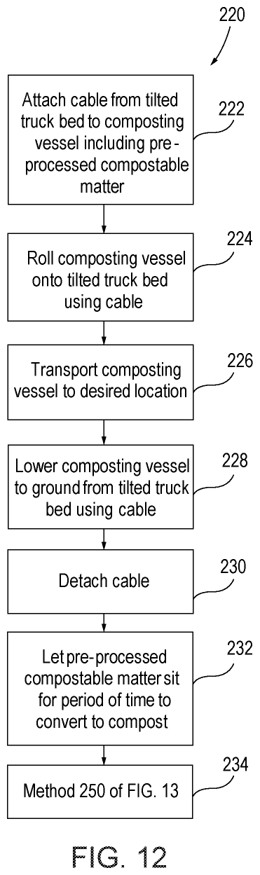

After operation 208, the method 200 may optionally proceed to operation 210 and the method 200 may proceed to method 220 of FIG. 12, and the composting vessel 110 including the pre-processed compostable matter may be transferred to another site for the composting process, as described in more detail below.

After operation 208, the method 200 may optionally proceed to operation 212 and the pre-processed compostable matter may be allowed to sit for a period of time to convert to compost. The period of time may depend on when the compost reaches or maintains a certain temperature. For example, when the compost reaches or maintains a temperature established by government regulations (e.g., by the Department of Public Health and Environment or the DPHE or similar state government agency), the period of time may end. Under current regulations, the pre-processed compostable matter may be allowed to sit in the composting vessel 110 until the compost reaches a temperature of 130 or 131 degrees Fahrenheit for a period of three days, or 150 degrees Fahrenheit for some pathogens. Temperature readings may be remotely accessed (e.g., via a smartphone). In some embodiments, the pre-processed compostable matter may be allowed to sit in the composting vessel 110 for 1-3 weeks.

During the composting process in the composting vessel 110, the blower 111 may be activated to push air through the compostable matter contained therein. For example, the blower 111 may be turned on to push air through the one or more pipes contained at least partially inside the vessel housing cavity 172.

Various conventional composting methods are contemplated in the composting vessel 110. As one example, aerated static pile (ASP) composting methods may be implemented in which air may be pushed through the composting vessel 110 using the one or more pipes and the blower 111. By using this method, labor costs may be reduced as it avoids the need to manually flip or turn the compostable material during the composting process (which is often the case using traditional windrow style composting methods). Using an ASP style system, the compostable waste may be considered “treated” under current regulations after three days, and, as such, is no longer managed as waste with heightened regulations.

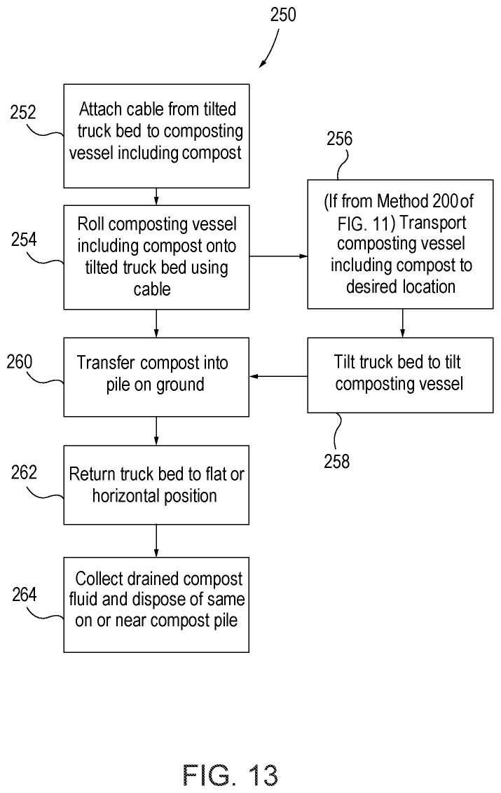

After operation 212, the method 200 may proceed to operation 214 and the method 200 may proceed to method 250 of FIG. 13, and the composting vessel 110 including the compost may be transferred to a different site for a compost maturation process, as described in more detail below.

FIG. 12 is a flow chart illustrating a method of transporting pre-processed compostable or organic matter to a site for composting. The method 220 begins with operation 222 and a cable from a tilted truck bed may be attached to the composting vessel including the pre-processed compostable matter. As discussed above, the composting vessel 110 may be a modified roll off container. Roll off containers are designed to be transported by specialized roll off trucks. Roll off trucks typically have truck beds that tilt down towards the ground and cables that extend downwards to hook to a roll off container to pull the roll off container up the truck bed. The composting vessel 110 may include a fastening mechanism (e.g., a bar, loop, or hook), e.g., similar to a fastening mechanism of a roll off container, that allows a cable (or cable hook or loop) of a roll off truck to hook onto the composting vessel 110 to facilitate lifting the composting vessel 110 onto the truck bed.

After operation 222, the method 220 may proceed to operation 224 and the composting vessel may be rolled onto the tilted truck bed using the cable. The wheels of the composting vessel 110 may facilitate rolling the composting vessel 110 onto the tilted truck bed as the cable pulls the composting vessel 110 upwards along the truck bed. The truck bed may be lowered to a horizontal position after the composting vessel 110 is in a proper position on the truck bed.

After operation 224, the method 220 may proceed to operation 226 and the composting vessel may be transported to a desired location. The pre-processed compostable matter may be transported to a second site for composting. For example, the composting vessel may be transported to a site where the compost will be used (e.g., a farm or park).

After operation 226, the method 220 may proceed to operation 228 and the composting vessel may be lowered to the ground with the cable. The composting vessel may be lowered in a similar manner as roll off containers. For example, the truck bed may be tilted or angled and the wheels of the composting vessel may facilitate the composting vessel rolling off the truck bed. The cable may control the speed with which the composting vessel rolls off the truck bed so that it does not slide off in an uncontrolled manner.

After operation 228, the method 220 may proceed to operation 230 and the cable may be detached from the fastening mechanism of the composting vessel 110.

After operation 230, the method 220 may proceed to operation 232 and the pre-processed compostable matter may be allowed to sit for a period of time to convert to compost in a similar manner as described above with respect to operation 212 of method 200 of FIG. 11.

After operation 232, the method 220 may proceed to operation 234 and the method 220 may proceed to method 250 of FIG. 13, and the compost may be transferred to the ground for a compost maturation process, as described in more detail below.

FIG. 13 is a flow chart illustrating a method of transferring compost to a site for compost maturation. The method 250 may begin with operation 252 and a cable from a tilted truck bed may be attached to the composting vessel including the compost, e.g., in a similar manner as described with respect to operation 222 of method 220 of FIG. 12.

After operation 252, the method 250 may proceed to operation 254 and the composting vessel including the compost may be rolled onto the tilted truck bed using the cable, e.g., in a similar manner as described with respect to operation 224 of method 220 of FIG. 12.

If method 250 proceeded from method 200 of FIG. 11 at operation 214 of method 200, the method 250 may proceed to operation 256 and the composing vessel including the compost may be transported to a desired location, e.g., as described with respect to operation 226 of method 220 of FIG. 12. The truck bed may be returned to a horizontal position with the composting vessel positioned thereon before transportation. For example, if the composting process occurred in the composting vessel at the same site as the sorting and grinding process, the composting vessel including the compost may be transported to a second site for maturation.

After operation 256, the method 250 may proceed to operation 258 and the truck bed may be tilted to tilt the composting vessel towards the ground. The composting vessel may remain in position on the tilted truck bed or lowered slightly by the cable.

After operation 258, or optionally, after operation 254, the method 250 may proceed to operation 260 and the compost may be transferred from the composting vessel into a pile on the ground. For example, one or both of the left vessel door 176a and the right vessel door 176b may be opened to release the contents of the composting vessel 110 onto the ground. In some embodiments, a conventional skid steer may be used to retrieve material that fails to fall out due to gravity.

The compost may be allowed to mature in the pile during the maturation process. For example, the compost may sit in the pile to mature for about a month or two before being used or spread.

After operation 260, the method 250 may proceed to operation 262 and the truck bed may be returned to a flat or horizontal position after the composting vessel is emptied. For example, the empty composting vessel may be returned to the sorting and grinding site for additional use.

After operation 262, the method 250 may proceed to operation 264 and drained compost fluid may be collected and disposed of on or near the compost pile. For example, liquid from the compost may filter into the drain 182 on the bottom vessel floor 170. The left and right guides 186a,b may help to guide the liquid into the drain 182. The basin or receptacle 185 below the drain 182 may collect the liquid. In some embodiments, the basin or receptacle 185 is removable to discard the liquid on the compost pile or on the ground. In some embodiments, the basin or receptacle 185 may include a valve that can be opened or released to allow the liquid to exit the basin or receptacle 185. For example, a container (e.g., a bucket) may be placed under the valve, the valve opened, and the liquid poured into the container for discarding on the compost pile or on the ground or another desired location.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the structures disclosed herein, and do not create limitations, particularly as to the position, orientation, or use of such structures. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order, and relative sizes reflected in the drawings attached hereto may vary.

While certain orders of operations are provided for methods disclosed herein, it is contemplated that the operations may be performed in any order and that operations can be omitted, unless specified otherwise.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

We claim:

1. A mobile composting system, comprising:
a sorting table, comprising a sorting surface and an inclined surface, wherein the sorting surface is configured to receive waste, the waste comprising compostable material, and the inclined surface is configured to receive the compostable material;
a grinder positioned below the inclined surface for receiving the compostable material, the grinder configured to grind the compostable material and produce ground compostable material; and
a conveyor belt having a first end positioned below the grinder to receive the ground compostable material and a second end.

2. The mobile composting system of claim 1, further comprising a composting vessel positioned below the second end of the conveyor belt, wherein the composting vessel comprises a plurality of wheels.

3. The mobile composting system of claim 2, wherein the composting vessel comprises at least one door and a bottom floor, the bottom floor comprising a drain positioned proximate to the at least one door for catching liquid and reducing liquid that escapes the composting vessel through one or more cracks in the at least one door.

4. The mobile composting system of claim 3, further comprising a receptacle positioned below the drain for receiving the liquid, wherein the receptacle comprises a valve for selectively releasing the liquid from the receptacle.

5. The mobile composting system of claim 3, wherein the composting vessel is a modified roll off container, wherein the modified roll off container is modified to include the drain and a corrosion-resistant coating on an interior surface of the modified roll off container to resist corrosion due to acid and heat produced from composting processes that occur inside the modified roll off container, wherein the corrosion-resistant coating comprises organic material.

6. The mobile composting system of claim 2, wherein at least an interior surface of the composting vessel is coated with a corrosion-resistant organic material comprising vegetable oil.

7. The mobile composting system of claim 2, wherein the composting vessel further comprises:
a composting vessel housing defining a composting vessel cavity;
one or more pipes positioned along a bottom floor of the composting vessel housing, wherein the one or more pipes are positioned at least partially outside the composting vessel cavity; and
a blower positioned adjacent an opening of the one or more pipes to push air from outside the composting vessel into the composting vessel cavity.

8. The mobile composting system of claim 1, wherein the sorting table comprises a right side wall and a left side wall on opposing sides of the sorting surface and inclined surface, wherein the right side wall and the left side wall prevent the waste from falling off the sorting table.

9. The mobile composting system of claim 2, wherein the sorting table is positioned on a sorting table platform a height above the ground, and the sorting table platform comprises a plurality of wheels.

10. The mobile composting system of claim 9, wherein the grinder and the conveyor belt comprise a plurality of wheels, and the sorting table, the grinder, and the conveyor belt are configured to move locations based on a location of the composting vessel and a configuration of a surrounding environment and wherein at least the conveyor belt is configured to move relative to the sorting table.

11. The mobile composting system of claim 9, wherein the sorting table platform comprises a standing platform and a sorting table stand extending up from the standing platform, wherein the sorting table stand comprises a sorting table stand surface positioned a distance from the standing platform, and wherein the sorting table is positioned on the sorting table stand surface.

12. The mobile composing system of claim 10, further comprising a garbage bin lifting mechanism, the garbage bin lifting mechanism comprising a plurality of wheels to facilitate movement of a garbage bin relative to the sorting table.

13. A method of pre-processing compostable material, comprising:
transferring waste comprising compostable matter onto a sorting table for sorting, wherein the sorting table comprises a sorting surface and an inclined surface, and wherein transferring the waste onto the sorting table comprises transferring the waste onto the sorting surface;
removing non-compostable matter from the waste; and
transferring the compostable matter from the sorting surface to the inclined surface, wherein the compostable matter slides down the inclined surface into a grinder positioned below the inclined surface and is ground inside the grinder into finer particles forming pre-processed compostable material.

14. The method of claim 13, further comprising transporting, via a conveyor belt having a first end positioned adjacent to the grinder, the pre-processed compostable material to a composting vessel positioned at a second end of the conveyor belt, wherein the composting vessel is located at a first location, and wherein the composting vessel comprises a plurality of wheels to facilitate moving the composting vessel to a second location.

15. The method of claim 14, wherein the composting vessel comprises at least one door and a bottom floor, the bottom floor comprising a drain positioned proximate to the at least one door for catching liquid and reducing liquid that escapes the composting vessel through one or more cracks in the at least one door when the composting vessel is moved to the second location.

16. The method of claim 14, further comprising allowing the pre-processed compostable material to compost in the composting vessel at the first location for a period of 1-3 weeks.

17. The method of claim 14, further comprising allowing the pre-processed compostable material to compost in the composting vessel at the second location for a period of 1-3 weeks.

18. A method of transporting a composting vessel from a first location to a second location for composting or maturation, comprising:
attaching a cable to a fastening mechanism coupled to the composting vessel, wherein the cable is coupled to a truck bed in a first tilted position, wherein the composting vessel comprises:
a composting vessel housing defining a composting vessel cavity holding pre-processed compostable matter or compost;
a plurality of wheels coupled to the composting vessel housing;
wherein the composting vessel housing comprises a bottom floor and a drain positioned on the bottom floor;
rolling the composting vessel onto the truck bed using the cable and the plurality of wheels, wherein liquid from the pre-processed compostable matter or compost is collected in the drain; and
transporting the composting vessel to a second location.

19. The method of claim 18, wherein the composting vessel cavity holds pre-processed compostable matter and the method further comprises:
lowering the composting vessel from the truck bed to a ground surface at the second location using the cable, wherein the truck bed is in a second tilted position when the composting vessel is lowered;
detaching the cable from the fastening mechanism; and
allowing the pre-processed compostable matter to compost in the composting vessel at the second location for a period of 1-3 weeks.

20. The method of claim 18, wherein the composting vessel cavity holds compost and the method further comprises:
opening a door of the composting vessel when the truck bed is in a second tilted position that tilts the composting vessel; and
allowing the compost to fall out of the composting vessel and into a compost pile on a ground surface at the second location.
